(19) United States
(12) Patent Application Publication
(10) Pub. No.: US 2024/0232185 A9
(43) Pub. Date: Jul. 11, 2024

(54) SYSTEM AND METHOD FOR ANALYZING UNSTRUCTURED VEHICLE LISTING DATA

(71) Applicant: Capital One Services, LLC, McLean, VA (US)

(72) Inventors: Elizabeth FURLAN, Bellevue, WA (US); Chih-Hsiang CHOW, Coppell, TX (US); Steven DANG, Plano, TX (US)

(73) Assignee: Capital One Services, LLC, McLean, VA (US)

(21) Appl. No.: 17/970,714

(22) Filed: Oct. 21, 2022

(51) Int. Cl. G06Q 40/02; G06F 16/242; G06Q 30/06

(52) U.S. Cl. CPC G06Q 40/025; G06F 16/243; G06Q 30/0609

(57) ABSTRACT

A system and method that facilitates a private transaction is disclosed. The system can retrieve textual information of a webpage containing vehicle sale related information for a vehicle listed for sale by an individual. Using a natural language processing (NLP) model, the textual information may be analyzed to extract vehicle sale related information for the vehicle. The system can compare the vehicle sale related information to known parameters for the vehicle to verify the authenticity of the vehicle sale related information. Based on verifying the authenticity of the vehicle sale related information, the system can determine whether to approve financing for the vehicle. Based on determining to approve financing for the vehicle, financing terms may be generated for the vehicle. The financing terms may be transmitted to client devices.

### TECHNICAL FIELD

Aspects relate to a system that uses natural language processing (NLP) to analyze unstructured data.

### BACKGROUND

Conventional computing systems do not facilitate the financing of vehicles in private transactions. Rather, conventional systems typically provide platforms that merely connect potential buyers and sellers. The platforms typically list vehicles for sale by sellers and can be viewed by the potential buyers, who then have to reach out to the seller and facilitate the transactions manually. These systems typically do not provide any intelligence or analysis for any of the parties to facilitate the private transaction. Moreover, conventional computing systems do not connect banks, credit unions, or financial services entities to so they can facilitate financing the private transactions. Thus, what is needed are improved computing systems and methods that can facilitate private transactions, by authenticating sales information for the parties and that connect all these entities involved to such transactions.

### SUMMARY

Aspects of this disclosure are directed to a system and methods that can retrieve textual information from a webpage containing vehicle related information for a vehicle listed for sale. The system is directed to sales by a private party (e.g., an individual) as opposed to a vehicle dealership. The webpage may be a publicly accessible webpage that lists vehicles for sale. In aspects, the webpage may be accessed by the system based on a user action. For example, the user action can have the user browse to the webpage and trigger the system to crawl the webpage to extract vehicle sale related information about the vehicle listed for sale. In aspects, the triggering may be done by having the user toggle a browser plugin to initiate a crawler process to crawl the webpage. The toggling may be done via the user clicking a button or an icon activating the browser plugin to transmit a hyperlink (or simply a link) of the webpage to the backend components of the system to allow the system to crawl the webpage via the link. In other aspects, the user can provide the link to the webpage via a software application, into which the user can paste the link to transmit the link to the backend components of the system. The software application may be a mobile application, desktop application, web-based application, etc. Once the link is received, the crawling process may be initiated to have the system crawl the webpage.

In aspects, the crawling process can result in the system parsing textual information on the webpage. Using natural language processing (NLP) techniques, the system can analyze the textual information and extract vehicle sale related information about the vehicle. The vehicle sale related information may be the price of the vehicle, the make and model of the vehicle, a description of the vehicle, the color of the vehicle, the trim of the vehicle, a mileage of the vehicle, etc. The NLP techniques also enable the system to understand the context of any written description of the vehicle, which can inform a decision on whether to offer financing for the purchase of the vehicle. Once extracted, the vehicle sale related information may be compared to known parameters for the vehicle to verify the authenticity of the vehicle sale information.

The known parameters refer to information about the vehicle that are or should be the same or similar to other vehicles that have the same make or model. For example, the known parameters may be vehicle options or features offered for the vehicle's make and model. The known parameters can also be a sale price for a vehicle with the same make and model as the vehicle being sold. Taking the example where the sales price of the vehicle is compared to the known sales price of another vehicle with the same make or model: by comparing the sale price of the two vehicles, the system can determine whether the sale price for the vehicle listed for sale falls in the range of a typical sale price for the same model vehicle with similar mileage, features, etc., and thus can determine whether the vehicle listing is authentic. In this way, the comparison can authenticate the vehicle sale related information.

In aspects, based on verifying the authenticity of the vehicle sale related information, the system can determine whether to approve financing for the vehicle. The determination may be performed based on having computer-implemented rules analyze parameters such as the market value of the vehicle, safety ratings of the vehicle, reliability ratings of the vehicle, an age of the vehicle, etc., and based on predetermined criteria, thresholds, and/or rules, determine whether to approve the financing. In aspects, based on determining to approve financing for the vehicle, the system can generate financing terms for the vehicle. Once generated, the system can transmit the financing terms to a client device to notify a potential buyer of the financing terms. The system can also notify the seller that the potential buyer has been approved for financing.

In aspects, to determine whether to approve financing for the sale, the computer-implemented rules can also analyze financial information related to the potential buyer. For example, information such as a credit score of the potential buyer, bank account balances, employment history, bankruptcies, etc., may be considered to determine whether to approve financing for the purchase.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is an example architecture of a system that can facilitate private transactions for the purchase of a vehicle, according to aspects of the disclosure.

FIG. 2 is an example method of operating the system, according to aspects of the disclosure.

FIG. 3 is an example architecture of components for devices that may be used to implement the system, according to aspects of the disclosure.

In the drawings, like reference numbers generally indicate identical or similar elements. Additionally, generally, the left-most digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of aspects of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing FIGURES. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

### System Overview and Function

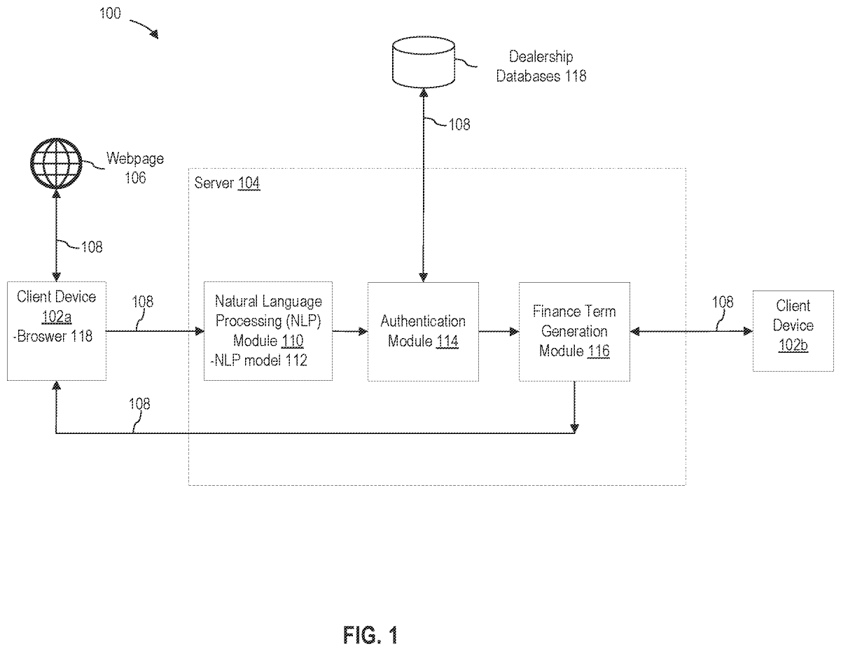

FIG. 1 is an example architecture of a system 100 that can facilitate private transactions for the purchase of a vehicle, according to aspects of the disclosure. In aspects, the system 100 can retrieve textual information from a webpage 106 with vehicle related information for a vehicle listed for sale by a private party (e.g., an individual) as opposed to a vehicle dealership. The webpage 106 may be a publicly accessible webpage that lists vehicles for sale. How the system 100 accesses and processes the textual information to facilitate the private transaction will be discussed further below.

In aspects, some or all of the components or modules of the system 100 may be implemented on client devices 102 and/or a server 104. If implemented on both the client devices 102 and the server 104, a client-server architecture may be employed such that the components or modules implemented on the client devices 102 and the server 104 can interface, communicate, and interact with one another. In FIG. 1, two client devices 102 are shown. These are client devices 102a and 102b. FIG. 1 will describe client device 102a as a device used by a potential buyer of the vehicle and 102b as a device used by the seller of the vehicle. How these devices operate with other devices of the system 100 (e.g., the server 104) will be discussed further below. While two client devices 102 are shown, this is exemplary. The system 100 may be implemented to use more or less client devices 102 in other implementations.

In aspects, the server 104 may be a variety of centralized or decentralized computing devices. For example, the server 104 may be a mobile device, a laptop computer, a desktop computer, grid-computing resources, a virtualized computing resource, cloud-computing resources, peer-to-peer distributed computing devices, a server farm, or a combination thereof. The server 104 may be centralized in a single room, distributed across different rooms, distributed across different geographic locations, or embedded within a network 108. The server 104 can couple with the network 108 to communicate with other devices, such as the client devices 102, on which a browser 118 may be installed. The client devices 102 may be any of a variety of devices, such as a smart phone, a cellular phone, a personal digital assistant, a tablet computer, a notebook computer, a laptop computer, a desktop computer, or a combination thereof. The server 104 and the client devices 102 may be stand-alone devices and work independently from one another.

The network 108 refers to a telecommunications network, such as a wired or wireless network. The network 108 can span and represent a variety of networks and network topologies. For example, the network 108 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 108. Cable, Ethernet, digital subscriber line (DSL), fiber optic lines, fiber to the home (FTTH), and plain old telephone service (POTS) are examples of wired communication that may be included in the network 108. Further, the network 108 can traverse a number of topologies and distances. For example, the network 108 can include a direct connection, personal area network (PAN), local area network (LAN), metropolitan area network (MAN), wide area network (WAN), or a combination thereof.

In aspects, the system 100 may begin its operation by receiving a hyperlink (or simply a link) to the webpage 106 listing a vehicle for sale. In aspects, the system 100 can access the webpage 106 via the link to extract textual information of the webpage 106. In aspects, the link may be provided through the action of a user of the system 100. The user may be a potential buyer of the vehicle listed for sale. In aspects, the user can use the client device 102a to provide the link to the system 100. For example, in aspects, the link may be provided based on the user browsing to the webpage 106 using browser 118 installed on the client device 102a. Once on the webpage 106 the user can trigger/toggle the system 100 to crawl the webpage 106 to extract the textual information on the webpage 106. For the purposes of this disclosure, it is assumed that the textual information includes vehicle sale related information about the vehicle listed for sale. The vehicle sale related information can include the price of the vehicle, the make and model of the vehicle, a description of the vehicle, the color of the vehicle, the trim of the vehicle, a mileage of the vehicle, or any other information pertinent to the sale of the vehicle.

In aspects, the triggering/toggling of the system 100 to crawl the webpage 106 may be done based on the user triggering/toggling a software application installed on the browser 118 to send the hyperlink associated with the webpage 106 to the backend components of the system 100 to initiate a crawling process. In aspects, the triggering/toggling may be done by the user triggering/toggling a mobile application, desktop application, or web application installed on or accessed with the client device 102a to send the hyperlink associated with the webpage 106 to the backend components of the system 100 to initiate the same crawling process. The crawling process can crawl the webpage 106 to extract the textual information. A person of skill in the art (POSA) will recognize how to implement a crawling process. In aspects, the software application, if installed on the browser 118, can take the form of a browser plugin, applet, etc. In aspects, the user can toggle the plugin, applet, etc. by clicking a button or icon to trigger/toggle the plugin, applet, etc. to send the hyperlink to the backend components of the system 100 to initiate a crawler process to crawl the webpage 106. Alternatively, the user can copy/paste or type the hyperlink to the webpage in a text box, window, etc. to send the hyperlink to the backend components of the system 100. Thus, the software application can interface between the backend components of the system 100 and the webpage 106 to allow the system 100 to crawl the webpage 106 via the hyperlink.

In aspects, the crawling process can extract the textual information of the webpage 106, including the vehicle sale related information. In aspects, once extracted, the textual information may be transmitted to the backend components of the system 100 to be analyzed and further processed. In aspects, the backend components of the system 100 can include modules installed on the server 104. These modules can include at least a natural language processing (NLP) module 110, an authentication module 114, and a finance term generation module 116.

In aspects, the textual information may be transmitted to the NLP module 110. The NLP module 110 can enable analyzing the textual information and enable the system 100 to extract meaning from the textual information. In aspects, this may be done by having an NLP model 112 implement NLP techniques to analyze the words of the textual information in order to extract keywords and intent/meaning of the sentences and paragraphs of the textual information. In aspects, the NLP model 112 can extract the keywords and determine the intent/meaning of the sentences and paragraphs using trained machine learning models such as the Bidirectional Encoder Representations from Transformers (BERT) developed by Google™ or the Robustly optimized BERT approach (RoBERTa) developed by Facebook™ to identify the keywords and determine the intent/meaning of the sentences and paragraphs. A POSA will recognize how to implement machine learning models such as BERT or RoBERTa to extract keywords, meaning, and intent from the textual information given this disclosure. In aspects, other machine learning tools may be used, such as syntactic maps, classifiers, etc. to determine relationships between words in the textual information and to assist in determining the intent/meaning.

By way of example, the NLP model 112 can extract keywords such as “Sale Price,” “Make,” “Model,” “Year,” etc., and determine that the keywords relate to certain vehicle sale related information describing the vehicle. The NLP model 112 can then look at the surrounding words or text to determine what values are associated with those keywords. For example, if the keyword “Sale Price” is identified, the NLP model 112 can look at the words or characters surrounding the keyword to determine if there is a numerical value indicating the sale price of the vehicle. Typically, such a sale price would be listed in the format “$XX,XXX” or “$X,XXX.” The NLP model 112 may be trained to recognize such patterns of text and/or characters, and if the surrounding text matches the pattern, the NLP model 112 can determine that the surrounding text represents the sale price of the vehicle for sale. The NLP model 112 can then extract the sale price based on the surrounding text. Once extracted, the sale price may be sent to further modules of the system 100 for further processing. The processing can include comparing the sale price to known parameters for the vehicle such as sale prices for similar vehicles with the same make, model, and features to verify the authenticity of the sale price. How the authentication is performed will be described further below. A similar process may be performed for other keywords found related to vehicle sale related information.

In aspects, the NLP model 112 can also be trained to extract intent/meaning from the textual information. For example, if there are sentences or paragraphs describing the vehicle the NLP model 112 may be trained to extract meaning from those sentences/paragraphs. The extracted meanings can assist the system 100 authenticate the sale related information and to ultimately determine whether to approve financing for the vehicle. By way of example, if a sentence/paragraph indicates that the vehicle was purchased in a particular year but is actually a make or model from another year, the NLP model 112 may be trained to recognize the meaning of the sentence so as to extract the correct year of the make or model of the vehicle. For example, if a sentence describing the vehicle states “2015 Honda Accord purchased in 2017,” the NLP model 112 may be trained to determine that the correct year that the vehicle was made was 2015. This may be done by training the NLP model 112 to recognize that words such as “purchased in” followed by a date indicate a year that the vehicle was purchased, while having a year followed by a vehicle make or model indicates a year that the vehicle was made. In this way, sentences/paragraphs may be parsed and meaning may be extracted from those sentences/paragraphs. In aspects, the NLP model 112 may be trained using a corpus of textual data that can have keywords, sentence combinations, etc., labeled to recognize the aforementioned type of patterns.

In aspects, once the NLP module 110 performs its function, control and the extracted keywords and/or extracted keywords, based on the determined intents/meanings of the sentences/paragraphs related to the vehicle sale related information, may be passed to the authentication module 114. The authentication module 114 can enable verifying the authenticity of the vehicle sale related data based on the extracted keywords. In aspects, the authentication may be done by having the authentication module 114 compare the extracted keywords to known parameters for the vehicle. The known parameters refer to information about the vehicle that are or should be the same or similar to other vehicles that have the same make, model, and features. For example, the known parameters may be vehicle options or features offered for the vehicle's make and model. The known parameters can also be a sale price for a vehicle with the same make and model as the vehicle being sold. The aforementioned are examples of what the known parameters may be. A POSA will recognize other known parameters can also be used to perform the authentication given this disclosure.

By way of example, in aspects, the comparison can compare the sales price listed for the vehicle for sale with a sales price of a similar vehicle with the same make, model, mileage, and features to determine whether they are approximately the same value or fall within a threshold value of one another (e.g., differ by 1%-5% of each other). In aspects, the comparison can also compare the features listed for the vehicle for sale with features of a similar vehicle with the same make and model to determine whether the features listed are consistent with features offered for that make or model. In aspects, the comparison can also compare colors for the vehicle for sale with colors of a similar vehicle with the same make or model to determine whether the color listed is consistent with colors offered for that make or model. The aforementioned are merely exemplary vehicle sale related information that may be compared to known parameters. In this way, the system 100 can authenticate whether the listing for the vehicle is authentic or not.

In aspects, the known parameters may be retrieved from dealership databases 118 of vehicle dealerships in a geographic area where the vehicle is being sold. Obtaining the known parameters from vehicle dealerships provides the benefit of obtaining reliable information for vehicle makes and models, since vehicle dealerships have accurate information about vehicles and representative market values for vehicles. Additionally, obtaining the known parameters from vehicle dealerships in a geographic area where the vehicle is being sold allows for sale prices to be compared for a geographic market. In this way, the system 100 can confidently authenticate and/or verify the vehicle listing and/or the vehicle sale related information. In aspects, the vehicle sale related information may be determined to be authenticated/verified if the vehicle sale related information matches with the known parameters (e.g., the color matches a color offered for that vehicle, etc.) or is within acceptable threshold values of the known parameters (e.g., the sale price is within a threshold value of a known sale price for a vehicle with the same make, model, and features).

In aspects, once the authentication module 114 performs the comparison and authenticates/verifies the vehicle sale related information, control may be passed to the finance term generation module 116 to determine whether to approve financing for the vehicle. If the finance term generation module 116 determines to approve financing for the vehicle, it can also generate financing terms for the vehicle.

In aspects, the finance generation module 116 can determine whether to approve financing for the vehicle based on executing pre-determined computer-implemented rules analyzing the vehicle sale related information and/or other information related to the vehicle's make, model, and/or features. For example, in aspects, the computer-implemented rules can analyze a market value of the vehicle, safety ratings of the vehicle, reliability ratings of the vehicle, or an age of the vehicle, etc. By analyzing these parameters, the computer-implemented rules can make a determination as to whether to approve financing for the vehicle.

By way of example, the computer-implemented rules can implement pre-qualification criteria such that if the vehicle is older than a certain age (e.g., 12 years old) no financing will be approved. In another example, if the safety ratings of the vehicle are below a particular rating or score, the computer-implemented rules can determine that no financing will be approved. In another example, if the reliability ratings of the vehicle are below a particular rating or score, the computer-implemented rules can determine that no financing will be approved. In another example, if the market value for the vehicle is above or below a certain monetary amount the computer-implemented rules can determine that no financing will be approved.

In aspects, the computer-implemented rules can use a combination of parameters to determine whether financing will be approved. For example, if the market value of the vehicle is below a certain monetary value typically approved for financing but the safety and reliability ratings are high, the computer-implemented rules can determine to approve financing for a vehicle. The aforementioned are merely exemplary as the types of rules that may be implemented to determine whether to approve financing. A POSA reading this disclosure will know how to implement other similar rules to determine whether to approve financing for the vehicle.

In aspects, the other information related to the vehicle's make, model, and/or features such as the market value of the vehicle, safety ratings of the vehicle, reliability ratings of the vehicle, or an age of the vehicle, etc. may be obtained by the finance term generation module 116 from third-party sources that have that information. Such sources can include commercial publications or services that can provide the information. In aspects, the system 100 can interface with these third-party sources, via application programming interfaces (APIs) or otherwise, to obtain the information.

In aspects, in addition to analyzing information related to the vehicle's make, model, and/or features, the determination whether to approve financing can depend on the financial status of the potential buyer of the vehicle. For example, the computer-implemented rules can also consider financial information of the potential buyer, for example, a credit score of the potential buyer, account balances of the potential buyer, a history of bankruptcies of the potential buyer, etc., to determine whether to approve the financing. For example, if the credit score of the potential buyer is below a certain threshold indicating poor or bad credit, the computer-implemented rules can determine not to approve financing. In another example, if the account balances or income of the potential buyer is below a particular monetary value, the computer-implemented rules can determine not to approve financing. In another example, if the potential buyer has over a threshold number of bankruptcies, the computer-implemented rules can determine not to approve financing. In aspects, a combination of these factors may be used to determine whether to approve financing. The aforementioned are merely exemplary types of financial information of the potential buyer that may be used by the system 100. A POSA, reading this disclosure, will know how to implement other similar rules to determine whether to approve financing based on the financial status of the potential buyer.

In aspects, if the finance term generation module 116 determines to approve financing for the vehicle, the finance term generation module 116 can further generate financing terms. In aspects, the financing terms can include an interest rate for a loan, an amount approved for a loan, a down payment required for the loan, or any other financing term typical of a vehicle financing. In aspects, the financing terms may be generated based on one or more further computer-implemented rules that may be executed by the finance term generation module 116 to determine the financing terms. For example, the rules can determine the rate for the loan based on a credit history of the potential buyer. For example, if the potential buyer has a good or excellent credit rating, a lower rate may be generated for the loan (e.g., 0% APR). If the potential buyer has poor credit, a higher rate may be generated for the loan. If the potential buyer has poor credit, a higher down payment may be required, as opposed to a potential buyer who has good or excellent credit, in which case a lower down payment may be required. In aspects, the financing terms can also be based on the type of vehicle. For example, a vehicle that has a value beyond a particular threshold monetary value can require a larger down payment than a vehicle with a vehicle that has a value below the threshold monetary value. The aforementioned are merely exemplary terms that may be generated. A POSA reading this disclosure, will know how to implement similar rules to generate the financing terms. Such rules will depend on the company or institution implementing the system 100 and its internal practices.

In aspects, if financing terms are generated, the financial term generation module 116 can transmit the financing terms to the potential buyer of the vehicle, the seller of the vehicle, or a combination thereof. For example, in aspects, the financing terms may be transmitted to the client device 102a to notify the potential buyer of the vehicle that the financing has been approved and to notify the potential buyer of the financing terms. In aspects, the financing terms separately or in conjunction may be transmitted to client device 102b to the seller of the vehicle to notify the seller of the vehicle that a seller has been approved to buy the vehicle. In aspects, the notification may be via an email, a phone call, a short message service (SMS) notification, a graphical user interface (GUI) showing the financing terms or notification, or other suitable notification method.

In aspects, the system 100 itself can take further steps to facilitate the completion of the private transaction or can pass control to other components or system of the company or institution implementing the system 100 to facilitate the completion of the private transaction. For example, further hyperlinks/link may be transmitted to both the potential buyer of the vehicle and the seller to complete next steps. For example, links may be sent to client devices (e.g., 102a and/or 102b) to have the potential buyer deposit funds for any down payments required to complete the purchase. In aspects, links can also be sent to the seller requesting the title transfer of the vehicle to the potential buyer.

The modules described in FIG. 1 may be implemented as or with instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100 or installed as a removable portion of the system 100.

The system 100 described provides benefits in that it implements a novel system and methods for facilitating financing of a private vehicle transaction. While the disclosure has described the vehicle transaction as a transaction for a car, the same system and methods may be used for other vehicle transaction such as that for a boat, motorcycle, scooter, plane, etc. The system 100 is novel in that it provides a way to use NLP techniques to parse vehicle listings from publicly available sources and to identify keywords and/or derive meaning from sentences/paragraphs describing the vehicle to extract keywords related to vehicle sale related information, which may be used to verify the vehicle listing, and to determine whether financing for the sale should be approved. The system 100 can also automatically generate financing terms based on the vehicle sale related information and other information related to the vehicle. In this way, the system 100 provides a fully automated way to generate financing terms for private transactions. This functionality provides benefits in that it uses computers to increase the efficiency by which private transactions take place and decreases the human-to-human interaction that currently takes place when private parties want to sell vehicles.

Additionally, the system 100 improves a computer's ability to understand the meaning of the information contained in vehicle listings. This improves the intelligence of computers and enhances computer human interactions.

### Methods of Operation

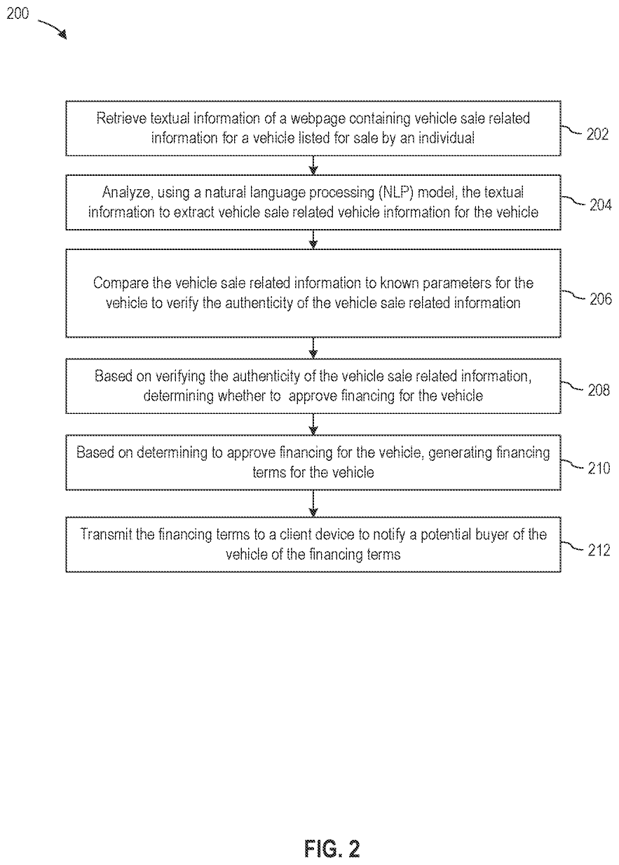

FIG. 2 is an example method 200 of operating the system 100, according to aspects of the disclosure Method 200 may be performed as a series of steps by a computing unit such as a processor. The processor may be on the server 104, the client devices 102, or a combination thereof.

At step 202, the system 100 can retrieve textual information of a webpage 106 containing vehicle sale related information for a vehicle listed for sale by an individual. In aspects, the vehicle sale related information can include the price of the vehicle, the make and model of the vehicle, a description of the vehicle, the color of the vehicle, the trim of the vehicle, a mileage of the vehicle, a description of the vehicle, etc. In aspects, the textual information can be retrieved via a link to the webpage that is provided to the backend components of the system 100 via a browser plugin. In aspects, the user can provide the link to the webpage via a software application. In aspects, based on the link being provided, a crawler process can be initiated to retrieve and extract the textual information.

At step 204, using a natural language processing (NLP) model 112 the textual information may be analyzed to extract the vehicle sale related information for the vehicle. In aspects, the NLP model 112 can implement NLP techniques to analyze the words of the textual information in order to extract keywords and intent/meaning of the sentences and paragraphs of the textual information. For example, the NLP model 112 can extract the keywords and determine the intent/meaning of the sentences and paragraphs using trained machine learning models such as the Bidirectional Encoder Representations from Transformers (BERT) developed by Google™ or the Robustly optimized BERT approach (RoBERTa) developed by Facebook™ to identify the keywords and determine the intent/meaning of the sentences and paragraphs.

At step 206, the system 100 can compare the vehicle sale related information to known parameters for the vehicle to verify the authenticity of the vehicle sale related information. For example, the known parameters may be vehicle options or features offered for the vehicle's make and model. The known parameters can also be a sale price for a vehicle with the same make and model as the vehicle being sold. The comparison can compare whether one or more of the vehicle sale related information is approximately the same value or falls within a threshold value of a similar known parameter.

At step 208, based on verifying the authenticity of the vehicle sale related information, the system 100 can determine whether to approve financing for the vehicle. At step 210, based on determining to approve financing for the vehicle, financing terms may be generated for the vehicle. In aspects, the financing terms may be generated based on computer implemented rules analyzing: a market value of the vehicle, safety ratings of the vehicle, reliability ratings of the vehicle, or an age of the vehicle. At step 212, the financing terms may be transmitted to a client device 102a to notify a potential buyer of the vehicle of the financing terms. Additionally, in aspects, a seller of the vehicle may be notified that the potential buyer has been approved to finance the vehicle.

The operation of method 200 may be performed, for example, by system 100, in accordance with aspects described above.

### Components of the System

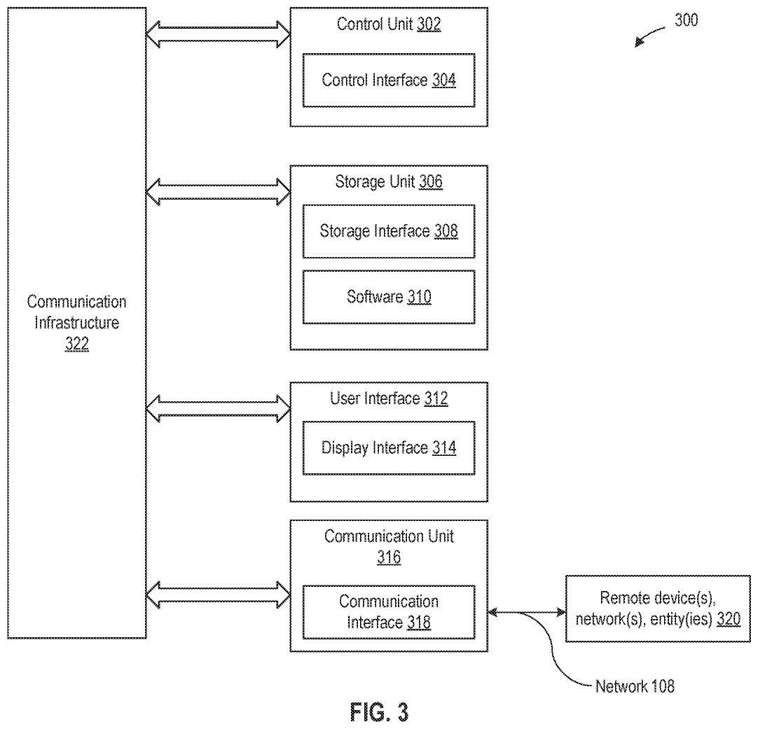

FIG. 3 is an example architecture 300 of components for devices that may be used to implement the system 100, according to aspects of the disclosure. The components may be the components of the server 104 or the client devices 102. In aspects, the components may include a control unit 302, a storage unit 306, a communication unit 316, and a user interface 312. The control unit 302 may include a control interface 304. The control unit 302 may execute a software 310 to provide some or all of the intelligence of system 100. The control unit 302 may be implemented in a number of different ways. For example, the control unit 302 may be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 304 may be used for communication between the control unit 302 and other functional units or devices of system 100. The control interface 304 may also be used for communication that is external to the functional units or devices of system 100. The control interface 304 may receive information from the functional units or devices of system 100, or from remote devices 320, such as the dealership databases 118, or may transmit information to the functional units or devices of system 100, or to remote devices 320. The remote devices 320 refer to units or devices external to system 100.

The control interface 304 may be implemented in different ways and may include different implementations depending on which functional units or devices of system 100 or remote devices 320 are being interfaced with the control unit 302. For example, the control interface 304 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 304 may be connected to a communication infrastructure 322, such as a bus, to interface with the functional units or devices of system 100 or remote devices 320.

The storage unit 306 may store the software 310. For illustrative purposes, the storage unit 306 is shown as a single element, although it is understood that the storage unit 306 may be a distribution of storage elements. Also for illustrative purposes, the storage unit 306 is shown as a single hierarchy storage system, although it is understood that the storage unit 306 may be in a different configuration. For example, the storage unit 306 may be formed with different storage technologies forming a memory hierarchical system including different levels of caching, main memory, rotating media, or off-line storage. The storage unit 306 may be a volatile memory, a nonvolatile memory, an internal memory, an external memory, or a combination thereof. For example, the storage unit 306 may be a nonvolatile storage such as nonvolatile random access memory (NVRAM), Flash memory, disk storage, or a volatile storage such as static random access memory (SRAM) or dynamic random access memory (DRAM).

The storage unit 306 may include a storage interface 308. The storage interface 308 may be used for communication between the storage unit 306 and other functional units or devices of system 100. The storage interface 308 may also be used for communication that is external to system 100. The storage interface 308 may receive information from the other functional units or devices of system 100 or from remote devices 320, or may transmit information to the other functional units or devices of system 100 or to remote devices 320. The storage interface 308 may include different implementations depending on which functional units or devices of system 100 or remote devices 320 are being interfaced with the storage unit 306. The storage interface 308 may be implemented with technologies and techniques similar to the implementation of the control interface 304.

The communication unit 316 may enable communication to devices, components, modules, or units of system 100 or to remote devices 320. For example, the communication unit 316 may permit the system 100 to communicate between the server 104 and the client devices 102. The communication unit 316 may further permit the devices of system 100 to communicate with remote devices 320 such as an attachment, a peripheral device, or a combination thereof through the network 108.

As previously indicated with respect to FIG. 1, the network 108 may span and represent a variety of networks and network topologies. For example, the network 108 may be a part of a network and include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 108. Cable, Ethernet, digital subscriber line (DSL), fiber optic lines, fiber to the home (FTTH), and plain old telephone service (POTS) are examples of wired communication that may be included in the network 108. Further, the network 108 may traverse a number of network topologies and distances. For example, the network 108 may include direct connection, personal area network (PAN), local area network (LAN), metropolitan area network (MAN), wide area network (WAN), or a combination thereof.

The communication unit 316 may also function as a communication hub allowing system 100 to function as part of the network 108 and not be limited to be an end point or terminal unit to the network 108. The communication unit 316 may include active and passive components, such as microelectronics or an antenna, for interaction with the network 108.

The communication unit 316 may include a communication interface 318. The communication interface 318 may be used for communication between the communication unit 316 and other functional units or devices of system 100 or to remote devices 320. The communication interface 318 may receive information from the other functional units or devices of system 100, or from remote devices 320, or may transmit information to the other functional units or devices of the system 100 or to remote devices 320. The communication interface 318 may include different implementations depending on which functional units or devices are being interfaced with the communication unit 316. The communication interface 318 may be implemented with technologies and techniques similar to the implementation of the control interface 304.

The user interface 312 may present information generated by system 100. In aspects, the user interface 312 allows the users to interface with the system 100. The user interface 312 can allow users of the system 100 to interact with the system 100. The user interface 312 may include an input device and an output device. Examples of the input device of the user interface 312 may include a keypad, buttons, switches, touchpads, soft-keys, a keyboard, touchscreens, a mouse, or any combination thereof to provide data and communication inputs. Examples of the output device may include a display interface 314. The control unit 302 may operate the user interface 312 to present information generated by system 100. The control unit 302 may also execute the software 310 to present information generated by system 100, or to control other functional units of system 100. The display interface 314 may be any graphical user interface such as a display, a projector, a video screen, or any combination thereof.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method 200 and system 100 are cost-effective, highly versatile, and accurate, and may be implemented by adapting components for ready, efficient, and economical manufacturing, application, and utilization. Another important aspect of the present disclosure is that it valuably supports and services the historical trend of reducing costs, simplifying systems, and/or increasing performance.

These and other valuable aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computer-implemented method comprising:
retrieving, by one or more computing devices, textual information of a webpage including vehicle sale related information for a vehicle listed for sale by an individual;
analyzing, by the one or more computing devices and using a natural language processing (NLP) model, the textual information to extract vehicle sale related information for the vehicle;
comparing, by the one or more computing devices, the vehicle sale related information to known parameters for the vehicle retrieved from remote databases within a geographic area where the vehicle is being sold, to verify the authenticity of the vehicle sale related information;
verifying, by the one or more computing devices, the authenticity of the vehicle sale related information based on determining the vehicle sale related information matches with the known parameters or is within acceptable threshold values of the known parameters;
in response to verifying the authenticity of the vehicle sale related information, determining, by the one or more computing devices, whether to approve financing for the vehicle;
in response to determining to approve financing for the vehicle, generating, by the one or more computing devices, financing terms for the vehicle;
transmitting, by the one or more computing devices, the financing terms to a client device of a potential buyer to notify the potential buyer of the vehicle of the financing terms; and
transmitting, by the one or more computing devices, a hyperlink to the client device of the potential buyer to deposit funds to complete the sale or a hyperlink to a client device of the individual selling the vehicle requesting a title transfer of the vehicle to the potential buyer.

2. The method of claim 1, further comprising receiving, by the one or more computing devices, a link to the webpage via a browser plugin.

3. The method of claim 2, further comprising:
initiating, by the one or more computing devices, a crawler process upon receipt of the link; and
retrieving the textual information of the webpage utilizing the crawler process.

4. The method of claim 1, based on determining to approve financing for the vehicle, further comprising, notifying, by the one or more computing devices, a seller of the vehicle that the potential buyer of vehicle is approved to purchase the vehicle.

5. The method of claim 1, further comprising determining, by the one or more computing devices, whether to approve financing for the vehicle based on computer-implemented rules analyzing: a market value of the vehicle, safety ratings of the vehicle, reliability ratings of the vehicle, or an age of the vehicle.

6. The method of claim 1, further comprising determining, by the one or more computing devices, whether to approve financing of the vehicle based on computer-implemented rules analyzing a credit score of the potential buyer of the vehicle.

7. The method of claim 1, wherein the known parameters for the vehicle are retrieved from vehicle dealerships in a geographic area where the vehicle is being sold.

8. A non-transitory computer readable medium including instructions for causing a computing system to perform operations comprising:
retrieving, by one or more computing devices, textual information of a webpage including vehicle sale related information for a vehicle listed for sale by an individual;
analyzing, by the one or more computing devices and using a natural language processing (NLP) model, the textual information to extract vehicle sale related information for the vehicle;
comparing, by the one or more computing devices, the vehicle sale related information to known parameters for the vehicle retrieved from remote databases within a geographic area where the vehicle is being sold, to verify the authenticity of the vehicle sale related information;
verifying, by the one or more computing devices, the authenticity of the vehicle sale related information based on determining the vehicle sale related information matches with the known parameters or is within acceptable threshold values of the known parameters;
in response to verifying the authenticity of the vehicle sale related information, determining, by the one or more computing devices, whether to approve financing for the vehicle;
in response to determining to approve financing for the vehicle, generating, by the one or more computing devices, financing terms for the vehicle;
transmitting, by the one or more computing devices, the financing terms to a client device of a potential buyer to notify the potential buyer of the vehicle of the financing terms; and
transmitting, by the one or more computing devices, a hyperlink to the client device of the potential buyer to deposit funds to complete the sale or a hyperlink to a client device of the individual selling the vehicle requesting a title transfer of the vehicle to the potential buyer.

9. The non-transitory computer readable medium of claim 8, wherein the operations further comprise receiving a link to the webpage via a browser plugin.

10. The non-transitory computer readable medium of claim 9, wherein the operations further comprise:
initiating a crawler process upon receipt of the link; and
retrieving the textual information of the webpage utilizing the crawler process.

11. The non-transitory computer readable medium of claim 8, wherein the operations further comprise notifying a seller of the vehicle that the potential buyer of vehicle is approved to purchase the vehicle.

12. The non-transitory computer readable medium of claim 8, wherein the operations further comprise determining whether to approve financing for the vehicle based on computer-implemented rules analyzing: a market value of the vehicle, safety ratings of the vehicle, reliability ratings of the vehicle, or an age of the vehicle.

13. The non-transitory computer readable medium of claim 8, wherein the operations further comprise determining whether to approve financing of the vehicle based on computer-implemented rules analyzing a credit score of the potential buyer of the vehicle.

14. The non-transitory computer readable medium of claim 8, wherein the known parameters for the vehicle are retrieved from vehicle dealerships in a geographic area where the vehicle is being sold.

15. A computing system comprising:
a memory configured to store instructions;
a processor, coupled to the memory and configured to process the stored instructions to:
retrieve textual information of a webpage including vehicle sale related information for a vehicle listed for sale by an individual;
analyze, using a natural language processing (NLP) model, the textual information to extract vehicle sale related information for the vehicle;
compare the vehicle sale related information to known parameters for the vehicle retrieved from remote databases within a geographic area where the vehicle is being sold, to verify the authenticity of the vehicle sale related information;
verify the authenticity of the vehicle sale related information based on determining the vehicle sale related information matches with the known parameters or is within acceptable threshold values of the known parameters;
in response to verifying the authenticity of the vehicle sale related information, determine whether to approve financing for the vehicle;
in response to determining to approve financing for the vehicle, generate financing terms for the vehicle; and
a communications unit including microelectronics, coupled to the memory and configured to:
transmit the financing terms to a client device of a potential buyer to notify the potential buyer of the vehicle of the financing terms; and
transmit a hyperlink to the client device of the potential buyer to deposit funds to complete the sale or a hyperlink to a client device of the individual selling the vehicle requesting a title transfer of the vehicle to the potential buyer.

16. The computing system of claim 15, wherein the communication unit is further configured to receive a link to the webpage via a browser plugin.

17. The computing system of claim 16, wherein the processor is further configured to:
initiate a crawler process upon receipt of the link; and
retrieve the textual information of the webpage utilizing the crawler process.

18. The computing system of claim 15, wherein:
the processor is further configured to notify a seller of the vehicle that the potential buyer of vehicle is approved to purchase the vehicle; and
the communication unit is further configured to transmit a notification notifying the seller.

19. The computing system of claim 15, wherein the processor is further configured to determine whether to approve financing for the vehicle based on computer-implemented rules analyzing: a market value of the vehicle, safety ratings of the vehicle, reliability ratings of the vehicle, or an age of the vehicle.

20. The computing system of claim 15, wherein the processor is further configured to determine whether to approve financing of the vehicle based on computer-implemented rules analyzing a credit score of the potential buyer.
